(19) United States
(12) Patent Application Publication
(10) Pub. No.: US 2009/0140128 A1
(43) Pub. Date: Jun. 4, 2009

(54) Methods, systems and apparatus for light concentrating mechanisms

(75) Inventors: Mark F. Oldham, Los Gatos, CA (US); Eric S. Nordman, Palo Alto, CA (US); Charles R. Connell, Redwood City, CA (US); Sun Hongye, Belmont, CA (US); Steven M. Blair, Salt Lake City, UT (US); Christina E. Inman, San Mateo, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applied Biosystems Inc., Foster City, CA (US)

(21) Appl. No.: 12/284,109

(22) Filed: Sep. 18, 2008

Related U.S. Application Data
(60) Provisional application No. 60/973,429, filed on Sep. 18, 2007.

(51) Int. Cl. G12B 21/06

(52) U.S. Cl. 250/216; 427/162; 427/553

(57) ABSTRACT

An embodiment relates generally to resonant structure. The resonant structure includes a substrate and a nano-bowtie antenna deposited over the substrate. The resonant structure also includes an enclosure deposited over the substrate and surrounding the nano-bowtie antenna, where the enclosure is configured to raise an enhancement level in the nano-bowtie antenna.

### CROSS REFERENCE TO RELATED APPLICATIONS

This application claims a priority benefit under 35 U.S.C. § 119(e) from U.S. Patent Application No. 60/973,429 filed Sep. 18, 2007, which is incorporated herein by reference.

### FIELD

This invention relates generally to light concentrating or enhancing mechanisms, more particularly to methods, apparatus and systems for light concentrating mechanisms to create a high energy field based on surface plasmons on a peripheral resonant cavity.

### DESCRIPTION OF THE RELATED ART

In non-stepwise single molecule sequencing (either free running or utilizing photo labile blockers) using fluorescently labeled nucleotides, it is necessary to affect a methodology to reduce the background from the labeled nucleotides so that the labels associated with the nucleotides that are incorporated can be properly observed. Some previously described methodologies include zero mode waveguides, plasmon resonance combined with quenching photo labile linkers, FRET pairs between the enzyme and the nucleotides, exclusion layers combined with TIRF, and similar other techniques.

The conventional methodologies have drawbacks and disadvantages. For example, a typical methodology typically involves blocking the excitation light except in a small area. This excitation light typically requires large expensive laser. Moreover, this methodology may generate a considerable amount of background noise, which degrades the signal quality.

### SUMMARY

An embodiment relates generally to resonant structure. The resonant structure includes a substrate and a nano-bowtie antenna deposited over the substrate. The resonant structure also includes an enclosure deposited over the substrate and surrounding the nano-bowtie antenna, where the enclosure to minimize background levels in the area around the bowtie structure.

Another embodiment generally pertains to a resonant structure. The resonant structure includes a substrate and a bulls-eye structure deposited over the substrate. The bulls-eye structure further includes a center aperture that is not a through-hole.

Yet another embodiment relates generally to a resonant structure. The resonant structure includes a substrate and a metal layer deposited over the substrate. The resonant structure also includes a metal dipole deposited onto the metal layer, where an enhancement area is created within a gap in the metal dipole. For the disclosed embodiments of the resonant structures described above and in greater detail below, these resonant/plasmonic structures can also be plasmonic focusing structures.

Yet another embodiment pertains generally to a method for creating resonant structures. The method includes depositing a layer of photo resist over a substrate and patterning the photo resist to create at least one resonant structure. The method also includes exposing the photo resist to solidify the exposed photo-resist and washing the photoresist. The method further includes depositing a layer of metal and removing the photoresist and respective metal.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an exemplary enclosed nano-bowtie antenna in accordance with an embodiment;

FIG. 2 illustrates a graph of the enhancement level for an enclosed nano-dipole shown in FIG. 1;

FIG. 3A illustrates a top view of an exemplary stepped bulls-eye structure in accordance with another embodiment;

FIG. 3B illustrates a profile view of the stepped bulls-eye structure shown in FIG. 3A;

FIG. 4A depicts a top view of another embodiment of a resonant structure in accordance with yet another embodiment;

FIG. 4B illustrates profile view of the resonant structure shown in FIG. 4A;

FIG. 4C depicts an reflection vs. light angle for the resonant structure shown in FIG. 4A;

FIG. 4D illustrates an enhancement vs. source angle for the resonant structure shown in FIG. 4A;

FIG. 4E illustrates a negative bowtie antenna structure in accordance with yet another embodiment;

FIG. 5 depicts a grid of nano-bowtie antennas in accordance with yet another embodiment;

FIG. 6 illustrates a process flow for creating resonant structures in accordance with yet another embodiment;

FIG. 7 depicts a beat pattern for the function sin(θ)cos(1.5*θ).

### DEFINITIONS

The following terms are used to describe the various embodiments detailed below.

Plasmon resonance can be defined as a collective oscillation of free electrons or plasmons at optical frequencies.

Surface plasmons are those plasmons that are confined to surfaces and that interact strongly with light resulting in a polariton. They occur at the interface of a material with a positive dielectric contact with that of a negative dielectric constant (usually a metal or doped dielectric).

Resonant structure can refer to a structure such as a nano-antenna or nano-particles that use plasmon resonance along with shape of the structure to concentrate light energy to create a small zone of high local electric field.

Fluorescence enhancement ratio (FER) can refer to a ratio of the fluorescence photons collected from the excitation zone associated with a resonant structure element relative to the photons that would be collected from an equivalent sized zone with no resonant structure element and with all other variables held constant.

The terms “polynucleotide” or “oligonucleotide” or “nucleic acid” can be used interchangeably and includes single-stranded or double-stranded polymers of nucleotide monomers, including 2′-deoxyribonucleotides (DNA) and ribonucleotides (RNA) linked by internucleotide phosphodiester bond linkages, or internucleotide analogs, and associated counter ions, for example, H+, NH4+, trialkylammonium, Mg2+, Na+ and the like. A polynucleotide can be composed entirely of deoxyribonucleotides, entirely of ribonucleotides, or chimeric mixtures thereof. Polynucleotides can be comprised of nucleobase and sugar analogs. Polynucleotides typically range in size from a few monomeric units, for example, 5-40 when they are frequently referred to in the art as oligonucleotides, to several thousands of monomeric nucleotide units. Unless denoted otherwise, whenever a polynucleotide sequence is represented, it will be understood that the nucleotides are in 5′ to 3′ order from left to right and that “A” denotes deoxyadenosine, “C” denotes deoxycytidine, “G” denotes deoxyguanosine, and “T” denotes thymidine, unless otherwise noted. A labeled nucleotide can comprise modification at the 5′ terminus, 3′ terminus, a nucleobase, an internucleotide linkage, a sugar, amino, sulfide, hydroxyl, or carboxyl. See, for example, U.S. Pat. No. 6,316,610 B2 to Lee et al. which is incorporated herein by reference. Similarly, other modifications can be made at the indicated sites as deemed appropriate.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of detection systems such as biomolecule detection, hybridization, DNA sequencing, FCS, single molecule, molecular complex, or bulk kinetic studies. etc., and that any such variations do not depart from the true spirit and scope of the present invention. Detection methods can include the detection of fluorescence, FRET, scattering, qdots, upconverting phosphors, etc. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Some embodiments generally relate to systems, apparatus, and methods for generating a high energy field through the use of surface plasmons. More particularly, in one embodiment, enclosed nano-antennas or dipoles can be configured to focus plasmon energy to a localized spot. For example, an enclosed bowtie nano-antenna can be fabricated that can focus energy to the center or gap in the structure, thus increasing plasmon intensity in a localized area. The enclosed bowties nano-antennas can also be used as a receiver. As such, they can be used to quench a molecule as well as to collect emissions. All of these metallic structures quench fluorescence if the fluorophore is close enough. To prevent undesired quenching the fluorophore can be spaced off the metal using a thin (approx −10 nm) dielectric layer. Such a layer can be made of glass, plastic or a chemical coating such as PEG. The thickness should be sufficient to space off a fluorophore so that it is not completely quenched, but not so far that it is spaced outside of the volume of the concentrated plasmons.

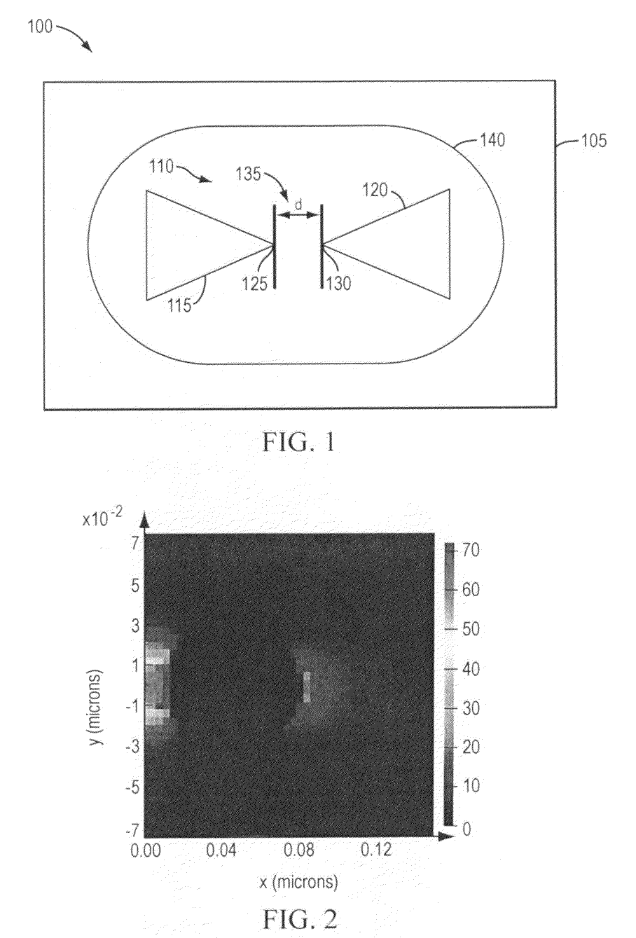

FIG. 1 illustrates an enclosed bow-tie nano-antenna 100. As shown in FIG. 1, the enclosed bowtie nano-antenna 100 can comprise an electromagnetically transparent substrate 105 upon which an antenna structure 110 is supported. The antenna structure 110 comprises a bowtie antenna (or dipole) including conductive arms 115 and 120, respectively. At terminations 125 and 130, conductive arms 115 and 120 are separated by a gap 135 having a transverse dimension d. In essence, conductive arms 115 and 120 form a dipole-like antenna. A metal enclosure 140 can surround the antenna structure 110. The metal of the metal enclosure 140 can be implemented with metals such as the coinage metals, aluminum, or alloys thereof. The metal enclosure 140 can serve to block interaction between the incoming light source and unbound labeled nucleotides. The metal enclosure 140 can provide an increase in enhancement in resonant activities. Moreover, the amount of coupling to the metal enclosure 140 that can cause second enhancement volumes is minimal.

FIG. 2 illustrates a graph of the enhancement level, Ex, in the XY-plane at the top of a dipole antenna. As shown, enhancement levels of 55 to 60 at the top of the dipole all the way across the gap, while the enhancement level at the right side of the dipole is about 10-15 across the gap to the surrounding metal, where the enhancement level within 5 to 10 nm is not useful due to fluorescent quenching by the metal enclosure.

There appears to be no coupling to the sides of the dipole. There may be some illumination of the bulk solution through the gap on both sides of the dipole, as the distance from one end of the metal enclosure is greater than λ/2. However, since the gap is about 20 nm on each side, the amount of excitation light which may pass is very minimal, as is the amount of emission light. Convolving excitation and emission illumination yields a small amount of light.

The enhancement level appears to be quite dependent on the length of the dipole, i.e., conductive arms 115, 120, and on the width of the gap 135 between the dipoles. In addition the enhancement is also dependent on the thickness of the structure, and the width of a dipole structure, and the angle of a bowtie structure. The optimum length of the dipole is dependent on the wavelength of absorbed light but the actual value of the optimum length appears to be broad.

The enhancement level appears to increase as the size of the gap 135 between the conductive arms 115, 120 decreases. However, the optimum width for the gap 135 for maximum useful enhancement appears to about 20 to 30 nm. At least 5 to 10 nm at each side will be effectively quenched because of the metal/fluorophores interaction. This volume at the edges of the gap 135 can be filled with a dielectric such as fused silica to prevent the fluorophores from occupying this volume, while leaving a space in the center of the gap which has high enhancement.

Other variations of the enclosed bow-tie antenna can include other type of antenna structures, such as log-periodic, spiral and slot antennas. More detailed description of the bow-tie antenna can be found in U.S. Pat. No. 5,696,372, which is hereby incorporated by reference in its entirety.

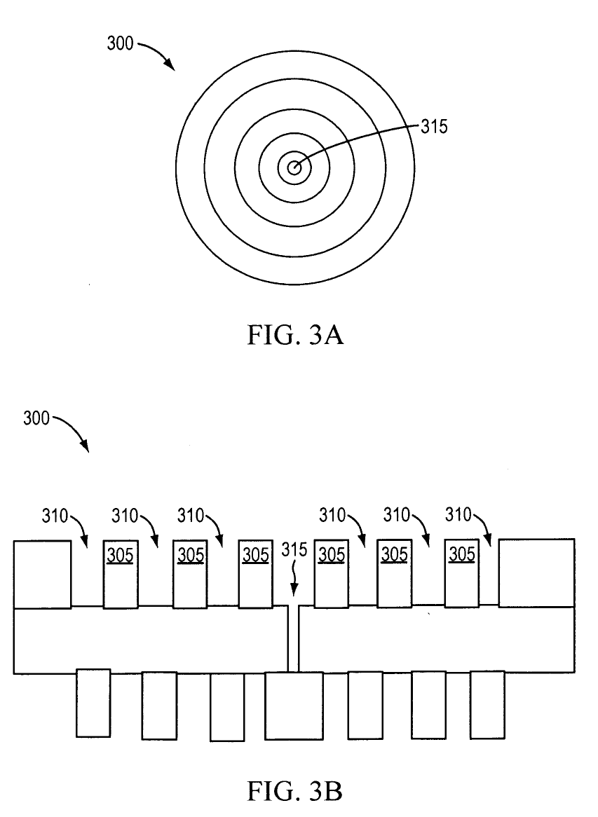

FIG. 3A illustrates a stepped bulls-eye antenna 300 in accordance with another embodiment. As shown in FIG. 3A, the stepped bulls-eye antenna 300 can be a circular nano-antenna configured to focus plasmon energy to a localized spot. The stepped bulls-eye antenna 300, can be positioned over a substrate. The stepped bulls-eye antenna 300 can include a center hole 315. As excitation light is directed on the stepped bulls-eye antenna 300 from an overhead source through a bulk solution, the stepped bulls-eye antenna 300 can direct plasmons to the center hole 315 of the stepped bulls-eye antenna 300. The focused plasmons then resonate vertically in the center aperture, creating quite high enhancement levels.

FIG. 3B illustrates a profile view of the stepped bulls eye antenna 300 in accordance with yet another embodiment. The stepped bulls-eye antenna 300 can be implemented with metal such as Al, Ag, Au, Cu, Pt, and/or alloys of these metals over a substrate. For embodiments with an adhesion layer, the adhesion layer can be implemented with chromium, nickel, aluminum, titanium, ICO plus other transparent oxides or other similar metal oxides. Alternatively, mercaptosilane can be used as an adhesion layer. The silane will bind to the silica or metal oxide surface, while the thiol (mercapto) will bind to any coinage metal used. The stepped bulls-eye antenna 300 can be formed from a set of concentric circular metal swaths 305 with intervening spaces 310. The width of the metal swaths 305 can be λ/2 at a height of about 50-100 nm and the intervening spaces 310 can have a width of about λ/2 with a spacing between each space and metal pair of λ, where λ is the wavelength of the excitation wavelength. The center hole 315 of the bulls-eye antenna 300 can have a diameter of about 15-50 nm and a depth of about 25 nm and does not penetrate through the metal, leaving about 25 nm of metal, i.e., a partially etched aperature.

The bulls-eye antenna 300 as a prototypical resonant structure has similarities to a zero mode wave guide but does not conform to the zero mode wave guide definition (no thru holes) or physics of operations as light does not penetrate. Rather, the bulls-eye antenna structure 300 creates a focused surface plasmon resonance in the stepped aperture. The momentum of metal electrons from the excitation light prevents the electrons from turning the corner. The bulls-eye structure can be mildly dependent on the thickness of the base metal but can be sensitive to the depth of the center aperture, where resonance occurs.

Another embodiment of the bulls-eye antenna 300 can be the circular swaths of material being implemented with silver over a fused silica substrate with the intervening spaces being shallow. The enhancement level for this embodiment can be higher, on the order of 140 to 220 and maintains this level of enhancement across the diameter of the partial aperture.

For this embodiment, the excitation light source is directed from above through a bulk solution. However, using appropriate thickness and groove spacing, it is possible to couple light from the bottom into a surface plasmon on the top. Moreover, it is likely to couple a plasmon on the bottom through an appropriately thin metal layer (less than the skin depth of the metal) on the bottom of a partial aperture, into the partial aperture and thus to the top of the metal.

The bulls-eye structure 300 can also be fabricated using other various techniques. For example, a two-step deposition technique could be used. More specifically, a first layer of metal can be deposited over a substrate. A second layer of circular swaths of metal can then be deposited over the first layer of metal. A variation of this technique can be depositing a second layer of metal and then etching the grooves with a focused ion beam. Another example can be depositing a layer of metal over a substrate and then etching the grooves of the bulls-eye structure. Such etching can be done using focused ion beam etching, or other more standard semiconductor processes.

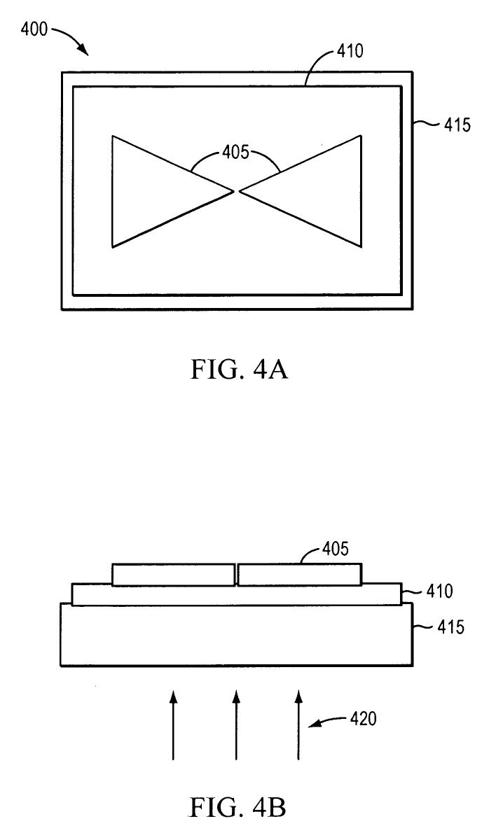

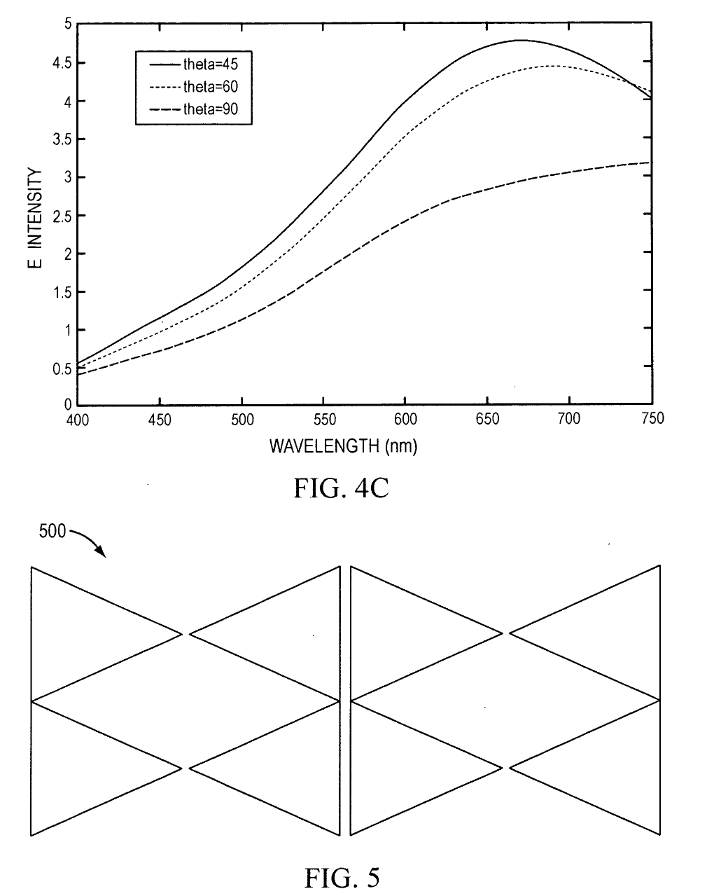

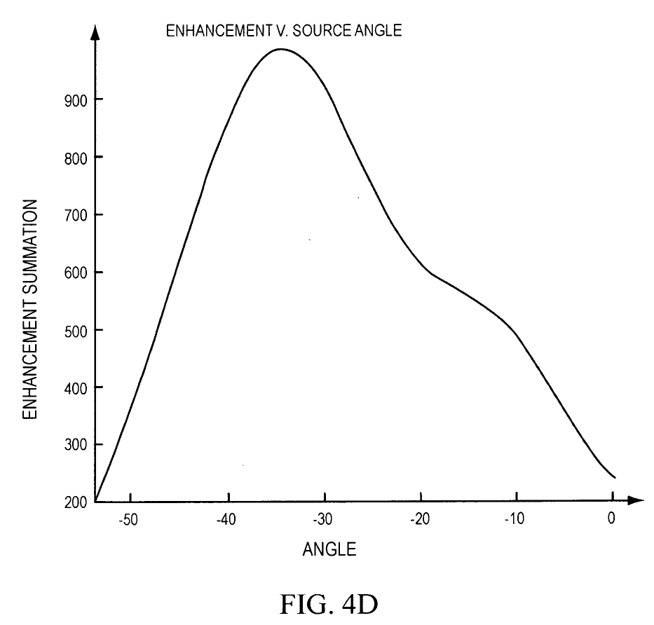

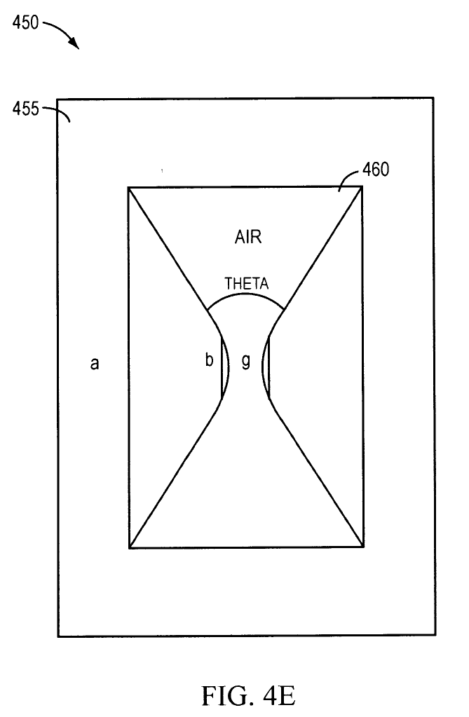

FIGS. 4A and 4B collectively illustrate another resonant structure 400 in accordance with yet another embodiment. As shown in FIG. 4A, the resonant structure 400 can comprise of a metal nano-bowtie antenna 405 (about 25-50 nm thick) positioned on a thin plane of metal 410 (5-15 nm thick), which is then adjacent to fused silica substrate 415. An excitation light 420 can illuminate the resonant structure 400 from below the substrate 415. The resonance enhancement can be found at the top of the gap between the dipoles of the metal bow-tie antenna although it is a lesser amount of enhancement between the ends, which can be a surprising result considering the plane of metal 410 does not short out the plasmons. In addition, the excitation light is coupled to the bow-tie antenna on the top, even though the incidence light can be normal versus the expectation of coupling through at the critical angle for SPCE, which is at a steeper angle than needed for TIRF. Finally, the enhancement is somewhat larger than observed for a dipole, i.e., bow-tie antenna, placed directly on the fused silica substrate, without the intervening layer of metal, which would be expected to attenuate the excitation light level.

The resonant structure 400 has good enhancement performance characteristics and can block most of the light from penetrating into a bulk solution. Alternatively, the blocking can be increased as the angle of light increases towards the SPCE critical angle (there is typically a steep change from 10-15 nm from the SPCE angle) as shown in FIG. 4C. FIG. 4C depicts a reflection versus light angle plot 430. Plot line 435 shows that transmission goes to zero approximately at 45 degrees, an angle which is attainable with conventional microscope objective.

Furthermore, the plane of metal 410 (using collection from the substrate side 415) will efficiently block any unwanted fluorescence in the bulk solution. Additionally, if the resonant structure 400 can be used to collect emission energy as well as for excitation, a polarizing filter can be used to block unwanted fluorescence from the bulk solution as the energy from the resonant structure will have a definite polarization.

In other embodiments of the resonant structure 400, a metal enclosure, such as the metal enclosure 140 in FIG. 1, can be implemented with the resonant structure as a combination of FIG. 1 and FIG. 4A-B.

FIG. 4D depicts an enhancement vs. source angle graph for the resonant structure 400. An optimum angle for this structure appears to be between 30 and 35 degrees, with a quite significant improvement in the enhancement level from the level achieved with normal incidence. An enhancement level of over 900 can be achieved without properly optimizing the shape and length of the bow-tie.

In some embodiments, a bowtie antenna 100 or other resonant structure, as described in U.S. Provisional Patent Application 60/826,079 and is hereby incorporated by reference in its entirety, can also be placed at the center of a bulls-eye structure 300 or other focusing structure, in place of a resonance cavity, to create a higher level of enhancement due to having a more efficient resonator. For this embodiment, the bulls-eye structure 300 can be implemented without the partially etched aperture 315.

The bow-tie antenna structure can be either positive or negative, i.e., it can be made of metal on a place or can be etched into a plane of metal. If the latter is implemented, lift off techniques can be used over an existing plane of metal. This can result in a bow-tie aperture, or an enclosed bowtie structure, which does not extend completely through the metal plane FIG. 4E depicts a negative bow-tie antenna structure 450, or bow-tie aperture.

As shown in FIG. 4E, the negative bowtie antenna structure 450 can comprise of metal area 455 which defines an air area 460, which does not have any metal. The air area 460 can be configured to be in the shape of a bowtie antenna, which can be implemented by an etch of a layer of metal, or by using a liftoff process. The negative bowtie antenna structure 450 can have a length a, a width of the narrowside b, a gap width g, and a theta θ, which is the angle of aperture. The resonance can occur across the gap, g, where the two metal sides are in closest proximity.

The bow-tie aperture, as depicted in FIG. 4 E, has a spacing or gap. In some embodiments, the bow-tie aperture can also be configured to be certain other shapes such as a C-shape, an H-shape, round shape, a square shape or other polygon.

Other embodiments of resonant structures can be attaching a Qdot or an up-converting phosphor directly to the enhancement region to provide a spectral shift. Another embodiment can be increasing the metal thickness in areas away from a bulls-eye structure or a dipole to further reduce transmission of excitation light into a bulk solution. Yet another embodiment can be multiple dipoles, with differing lengths, and thus differing resonant frequencies which can be used at differing angles, with matching polarization angles from sources of matching wavelengths. The different lengths of dipoles can be used to couple in different excitation wavelengths or to couple out different emission wavelengths.

Other embodiments can use different lengths and thus resonant frequencies on different sides of a dipole pair. Yet other embodiments can use different excitation frequencies that are relatively close in frequency to a single dipole, which is due to the relatively wide resonant frequencies of the dipoles. The enhancement level of this configuration is not optimum. However, it is not degraded too badly.

In general, four parameters have to be considered for the above-mentioned structures: (1) coupling plasmons to a desired location (specifically, from the excitation in a fused silica substrate to the interface between the aqueous solution and the metal); (2) focusing plasmons; (3) creating a resonant structure for the plasmons, which can be resonant in either the z and/or xy axes; and (4) preventing excitation light or coupled plasmons from undesired areas.

Yet another embodiment relates generally to photo-activated processes. More particularly, since surface plasmons are not light nor electromagnetic waves, but electron oscillations, the surface plasmons can be used to activate the many photo-activated processes that are initiated by photons, such as photo-cleavable linkers or photo-activated attachment. An example of how surface plasmons can be used to activate a photo-activated process is described in U.S. Patent Application 2007/0017791 to Hyde, published on Jan. 25, 2007, and is hereby incorporated by reference. An example of the chemistry and/or physics for photo-cleavable linkers is described in U.S. Pat. No. 6,057,096 to Rothschild et al. issued on May 2, 2000, which is hereby incorporated by reference in its entirety. An example of the chemistry and/or physics for photo-activatable molecules is described in U.S. Pat. No. 5,998,597 to Fisher et al., issued on Dec. 7, 1999, which is incorporated by reference in its entirety. An example of the chemistry and/or physics for attachment methods and molecules for photo-activated process is described in U.S. Pat. No. 6,967,074 to Duffy et al., issued on Nov. 22, 2005, which is incorporated by reference in its entirety.

For the above described resonant nanostructures, a method of optical interference can be used to create parallel lines. The interference lines can be rotated and make multiple interference lines at angles with respect to each other, using multiple exposures. Accordingly, this technique can be used to create array of holes or grids of lines. Other uses of this optical interference method can be used to create bow-tie dipoles.

FIG. 5 illustrates a partial view of a grid of bow-tie dipoles 500. As shown in FIG. 5, the grid of bow-tie dipoles 500 includes a set of 45-degree triangles with 70 and 100 nm spacings. Although FIG. 5 depicts 45-degree triangles with 70 and 100 nm spacings, other angles and spacing can be used as well as lines with different widths, spacings, and angles without departing from the scope and spirit of the embodiments. The different types of triangles can have different plasmon frequencies relative to the polarization angle of the excitation light. The plasmon polaritons can then create electric field enhancement volumes at the tips of the triangles. If one of the channels is wider than the others, a blunt tip can be created.

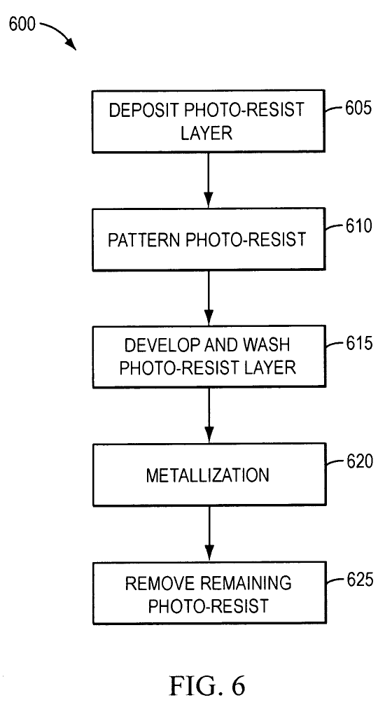

FIG. 6 shows a flow process 600 to create the bow-tie dipoles shown in FIG. 5. As shown in FIG. 6, in step 605, a layer of photo-resist can be deposited onto an appropriately transparent substrate, such as fused silica (SiO₂). In step 610, the pattern of the dipoles can be patterned on the photo-resist using the interference patterns. The exposed positive photo-resist is cross-linked, i.e., solidified, as a result of light exposure. In step 615, the photo-resist is then developed and washed, leaving lines forming the lines of an array of triangles (with the center of the triangles empty). In step 620, the substrate is metallized, filling the open triangles and coating the top of the photo-resist outline. In step 625, the photo-resist is then removed with the metal on top of the photo-resist, using a standard lift-off process.

Other embodiments of flow process 600 contemplate using a negative photo-resist, where the substrate is metallized before coating with the photo-resist. The developed photo-resist then has open gaps between the triangles of cross-linked photo-resist. The metal under the gaps is then removed using an etching process such as a chlorine etch.

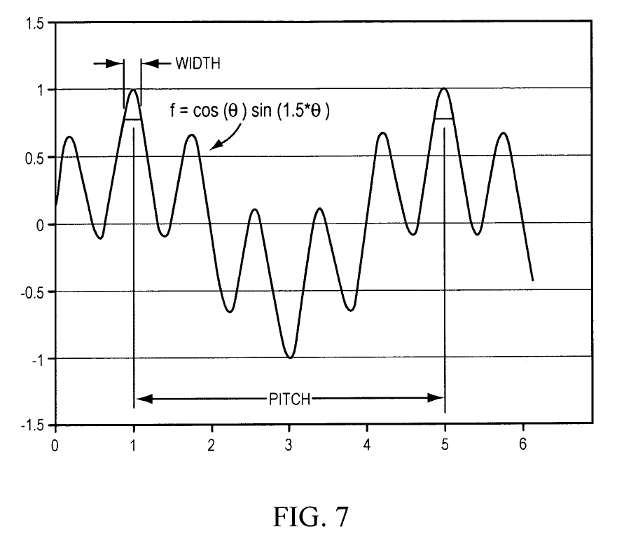

Some embodiments also contemplate creating narrower lines relative to the size of the triangles. More specifically, a beat pattern, for example, can be used to create a finer/narrower lines using the function cos(θ)sin(1.50) for a given pitch, as shown in FIG. 7. Accordingly, a more complex interference pattern can be generating using a combination of cos(θ) and sin(1.5*θ). Yet other embodiments contemplate using a phase shift mask to create patterns for resolutions below the normal diffraction limit of light.

Another variation of process flow 600 can use nano-imprinting techniques, which offers more flexibility. More specifically, rather than using a phot-lithographic process, nano-printing can be used to pattern an etch resist. As a result, it is not required that simple triangles be only created. Other variations of process flow 600 can include using techniques such as e-beam lithography, focused ion-beam, nano-sphere lithography, etc.

Another method of fabricating the above-mentioned plasmonic structure. More particularly, deposit an adhesion layer over a substrate such as fused silica. The adhesion layer can be chromium, nickel, or metal oxide. A plasmonic metal layer can then be deposited over the adhesion layer. The plasmonic metal can be a coinage metal such as Al, Pt, Zn, Au, Ag, Cu, etc. A third layer is then deposited over the plasmonic metal layer. The third layer can be implemented with a variety of materials such as metal or dielectric such a SaO₂, silica, amorphous silicon, silicon nitride, or other similar dielectric.

The third layer can then be used as an etch match. More specifically, pattern a photoresist or an e-beam resist on the third layer. The pattern is then transferred into the third layer. Subsequently, the pattern can then be transferred into the second and first layers. The first layer can be used as an etch stop, to prevent etching into the glass. Alternately, the first and second layers can be etched together. If the first layer is used as an etch stop, it can be retained as part of the structure, or it can be etched in a later etch process.

A variation of the previously described fabrication process can include depositing a thin dielectric layer as a standoff layer, which is described in U.S. patent application Ser. No. 11/749,411 filed on May 16, 2007 to Reel et al., which is incorporated by reference in its entirety. The lateral dimensions of the aperture in the dielectric which surrounds the resonant structure can be greater than or smaller than λ/2. The dielectric can also provide optical confinement, which is described in U.S. Patent Publication 2006006264, published on Mar. 23, 2006, which is incorporated by reference in its entirety. Although the dielectric layer can be a stand-off layer, the dielectric layer can also function as an etch mask in the fabrication process.

Different metals and different alloys of metals can be used to enable different plasmon resonances for different areas of a resonant structure. Gold can be useful for wavelengths greater than 530 nm, aluminum or silver is preferred for use with all visible wavelengths. A consideration in choosing a metal is the surface decay length, which limits the number of times a plasmon polariton can resonate before being absorbed and converted to heat.

However, it is not necessary that metals be the only constituents of resonant and/or focusing structure. Embodiments of these resonant and/or focusing structures can be created in part by using dielectric materials.

Light energy can be coupled into these structures using conventional microscopy techniques or can be coupled in using waveguides, in particular using photonic crystal waveguides as described in U.S. Provisional Application 60/826,079.

Additional enhancement can be achieved by the combining a plasmonic structures. For examples, a bead, nano-shell, nano-rice, nano-crescent, or other similar structure can be localized to interact with a bowtie, bulls-eye or other similar structure. Such localization can utilize a photo-actuated attachment. Structured patterns or enhancement zones can provide patterns for structured attachment of nano particles, as well as providing additional enhancement for both excitation and collection.

The above-mentioned resonant/focusing structures can be used in various detection systems. For examples, these plasmonic structures can be use for biomolecule detection such as protein detection using antibody receptors or ligands, hybridization, etc.

These resonant and/or focusing structures can also be used for photo-cleavable linkers and photo-activated attachment. Conventional descriptions of such compounds and their use refer to light, electromagnetic radiation or electromagnetic waves as the energy source for breaking the bonds in a photo-cleavable linker or activating a photo-activatable attachment site. Although a plasmon polariton is equally capable of being such an energy source for photo-cleavable linkers and photo-activated attachment, a plasmon polariton is not light, electromagnetic radiation, or an electromagnetic wave. Instead, a plasmon polariton is a collection of oscillating electrons. Moreover, a surface plasmon polariton structure can also deliver highly localized heating for thermal effects on diffusion and reactions.

For the above-described resonant and/or focusing structures, it can be desired to place a molecule(s) in a specific area of highest enhancement. However, if this attachment is done randomly, a high background noise can be a likely result.

One method to counter the high background noise can be photo activation, where the activation is achieved using the enhancement from structure to preferentially attach to the areas of highest enhancement. Although there will be attachment in areas with lower (or no) enhancement, the signal produced by a fluorophore in those locations will be proportionally lower, and similarly, there will be proportionally more enhancement in regions with high enhancement relative to areas with lower or no enhancement. Thus if the enhancement in the desired location is sufficiently higher than in desired locations than in unintended locations, the signal from fluorophores in the unintended locations can be filtered out using software as background. For example, if in a bow-tie structure the center gap has an enhancement level of 100, and the larger ends have an enhancement level of 10. Such a structure will have an equal number of attachments in the center gap, and on the larger ends, but as there is 10 times as much enhancement in the center, the signal from a molecule in the center gap will be 10 times as high as for a molecule attached at the ends.

To reduce attachment in unpreferred areas of the structure, A thin layer of a different metal may be used to prevent attachment to parts of the structure. For example, a chromium layer may be used on the top surface of a gold or silver structure. If a thiol attachment chemistry is used, it will not attach to the chromium layer, but only to the silver or gold. Thus the tops of the structures, and if a trench bow-tie structure is used, the planar surface between the structures, can be prevented from having any fluorophores attached. If the layer is sufficiently thin, on the order of 5 nm or less, it will not significantly affect the plasmonic characteristics of the structure. Such a layer serves a further purpose in acting as an etch resist. It is also possible to use a chromium adhesion layer. In this case, a photoresist is initially exposed and developed, permitting the etching of the top chromium layer. The chromium may then be used as a etch resist using a different etch chemistry. The bottom chromium layer will also act to prevent over-etching into the fused silica.

Another technique to prevent attachment in unpreferred areas, a photoresist layer may also be used to prevent attachment to the structure. After the structure is created, a thin photoresist layer may be applied over the structure. Light may then be applied to the structure; the photoresist will be preferentially exposed in the areas of highest enhancement. As the photoresist responds in a nonlinear fashion to the exposure of light, typically a factor of 2:1 is needed between exposure and nonexposure, thus a factor of 3:1 in enhancement between desired areas and unintended areas will enable sufficient tolerance to insure that exposure (and nonexposure) have appropriately occurred. The photoresist is then developed, which should create holes in the area of high enhancement. Attachment or photoattachment may then be done. The thickness of the photoresist is likely to be critical for many types of structures, as the enhancement region does not extend much above the structure, possibly as little as 5 to 10 nm. Some structures have enhancement regions which extend considerably above the structure; one example of this is the stepped aperture which creates an almost collimated enhancement region extending above the step aperture.

Yet another technique can be to use differences in the gold film to postion binding moieties at the enhancement sites. In this method, the gold surface is initially modified with an alkanethiol (likely a PEG-terminated thiol to prevent non-specific binding of dye-labeled molecules to the surface). After initial functionalization, the surface is exposed briefly (<30 seconds) to a thiol with a terminal binding moiety (like biotin). With such a brief exposure, these molecules should only insert into the defect sites in the gold film (Cygan et al. JACS 1999, 120, 2721-2732; Lewis et al. JACS 2004, 126, 12214-12215, which is hereby incorporated by reference in its entirety). The gold film should have more defect sites at the tips of the bow-tie structure, making the thiol with the binding moiety preferentially bind there.

Yet another technique uses two photon photo-physics. If a structure is illuminated with a high intensity pulse, the structure can create polaritons (and photons) at λ/2; this will only occur at areas of high enhancement. Photo-attachment will then occur only at the areas of high enhancement, and the photochemistry can potentially utilize the UV excitation. For example, this could be used to preferentially attached binding moieties such as biotin, benzophenone or other similar compounds in an area of greatest enhancement. After the using two-photon technique, the normal enhancement of lower enhancement can be used later on for analysis purposes in the same area. Similarly, a photoresist which responds at lower wavelengths can be exposed as previously described.

Yet another technique uses a photoresist, which polymerizes due to exposure, blocking access to the volumes with high enhancement. Previously attached linkers can then be removed in all areas except those which are covered by the exposed and developed photoresist. Alternately, this exposed surface can be chemically treated or coated such that linkers will not bind, the photoresist can be removed, and linkers preferentially attached in the areas of high enhancement.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A resonant structure comprising:
a substrate;
a nano-bowtie antenna deposited over the substrate; and
an enclosure deposited over the substrate and surrounding the nano-bowtie antenna, wherein the enclosure configured to raise an enhancement level in the nano-bowtie antenna.

2. The resonant structure of claim 1, wherein the substrate is fused silica.

3. The resonant structure of claim 1, wherein the nano-bowtie antenna is implemented with aluminum.

4. The resonant structure of 1, wherein the nano bowtie antenna is patterned using an optical interference.

5. A resonant structure comprising:
a substrate;
a bulls-eye structure deposited over the substrate wherein the bulls-eye structure further comprises a center aperture that is not a through-hole.

6. The resonant structure of claim 5, wherein the bulls-eye structure further comprises plurality of circular metal swaths deposited over the substrate.

7. The resonant structure of claim 6, wherein the bulls-eye structure further comprises of circular intervening spaces created between two circular metal swaths.

8. The resonant structure of claim 5, further comprising a nano-dipole over the center aperture.

9. A resonant structure, comprising:
a substrate;
a metal layer deposited over the substrate; and
a metal dipole deposited onto the metal layer, wherein an enhancement area is created within a gap in the metal dipole.

10. The resonant structure of claim 9, wherein the substrate is fused silica.

11. The resonant structure of claim 9, further comprising one of a Qdot and an upconverting phosphor in the enhancement area.

12. The resonant structure of claim 9 comprising a plurality of nano bowtie antennas, each antenna having a different length from each other and at a different angle.

13. A method for creating resonant structures, the method comprising:
depositing a layer of photo resist over a substrate;
patterning the photo resist to create at least one resonant structure;
exposing the photo resist to solidify the exposed photo-resist;
washing the photoresist;
depositing a layer of metal; and
removing the photoresist and respective metal.

14. The method of claim 13, wherein the photo resist patterning is performed using an optical interference technique.

15. The method of claim 13, wherein the resonant structure is further associated with one of a Qdot and an upconverting phosphor.

16. The method of claim 13, wherein the substrate comprises a fused silica over which the layer of photo resist is deposited.

17. The method of claim 13, wherein the resonant structure is formed as a nano-bowtie antenna or bulls-eye antenna.

18. The method of claim 17, wherein the resonant structure is formed as a plurality of nano bowtie or bulls-eye antennas, wherein at least some of the antennas are formed to have differing characteristics.

19. The method of claim 18, wherein the differing characteristics of the nano bowtie or bulls-eye antennas are reflected in differing lengths or sizes from each other.

20. The method of claim 18, wherein the differing characteristics of the nano bowtie or bulls-eye antennas antennas are reflected in differing angles or placements from each other.
